(19) United States
(12) Patent Application Publication
(10) Pub. No.: US 2026/0091812 A1
(43) Pub. Date: Apr. 2, 2026

(54) ASSISTED DRIVING SYSTEM AND METHOD FOR RAIL TRAIN BASED ON THREE-DIMENSIONAL MODELING

(71) Applicant: GA SKYTRAIN MOBILITY GROUP, LLC, Peachtree Comers, GA (US)

(72) Inventors: WEIFENG TANG, Jiangyin City (CN); KEYI CHEN, Jiangyin City (CN); CHONGGENG WEI, Chendu City (CN); BINGLIANG ZHANG, Jiangyin City (CN)

(21) Appl. No.: 19/318,469

(22) Filed: Sep. 4, 2025

(30) Foreign Application Priority Data
Sep. 30, 2024 (CN) 202411385990.5

(51) Int. Cl. B61L 27/57; B61L 25/02; G05B 17/02

(52) U.S. Cl. CPC B61L 27/57; B61L 25/021; B61L 25/025; G05B 17/02

(57) ABSTRACT

The invention discloses an assisted driving system and method for a rail train based on three-dimensional modeling. The system includes laser radars arranged along two sides of a rail such that maximum detection ranges of two adjacent laser radars positioned at the same side of the rail intersect in the rail extension direction; cameras arranged along two sides of the track such that visual field ranges of two adjacent cameras positioned on the same side of the track intersect in the track extension direction; a three-dimensional model building device respectively connected with the laser radar and the camera signals, and original three-dimensional models on two sides of the track built based on point cloud data and image data uploaded by the laser radar and the camera; and an early warning device arranged on a train for assisting driving and connected with the three-dimensional model building device signals.

### CROSS-REFERENCE TO RELATED PATENT APPLICATION

This application claims priority to and the benefit of Chinese Patent Application Serial No. 202411385990.5, filed Sep. 30, 2024, which is incorporated herein in its entirety by reference.

### FIELD OF THE INVENTION

The invention relates generally to the field of rail trains, and more particularly to a system and a method for assisting the driving of rail trains based on three-dimensional modeling.

### BACKGROUND OF THE INVENTION

The current rail trains have fixed routes, fixed stations, and a specified speed, so the rail trains are safe and reliable. Due to the high speed, large mass, and high inertia of rail trains, the response time of rail trains to emergencies is longer than that of ordinary cars.

In order to ensure the safety of rail trains, they are usually placed in a closed environment to prevent outside vehicles from entering the track. As traffic conditions become more and more congested, the amount of closed rail transportation will continuously decrease-leading to private vehicles and wild animals entering the track. In addition, in harsh natural environments, there will be sudden natural conditions such as road collapses and landslides.

If an object that suddenly enters the track is not discovered in time, it will cause a very serious traffic accident. Therefore, when driving a rail train, the driver needs to concentrate and observe whether there are any emergencies in the field of vision. If an emergency occurs, emergency braking should be performed. This method has great defects in rail train driving. The driver's field of vision will be affected by factors such as rainy weather, terrain obstruction, and haze. Therefore, in practice, it is easy for the driver to discover the emergency before the train can slow down, which would lessen traffic accidents.

### SUMMARY OF THE INVENTION

The summary of the application is intended to introduce concepts in a simplified form that are described in detail later in the detailed description section. The summary of the application is not intended to identify key features or essential features of the claimed solution, nor is it intended to limit the scope of the claimed solution.

As a first aspect of the present invention, in order to solve the technical problem that a driver cannot discover an emergency situation in time, the present invention provides a driving assistance system for a rail train based on three-dimensional modeling, comprising of:
a plurality of laser radars arranged along both sides of the track, and the maximum detection ranges of two adjacent laser radars located on the same side of the track intersect in the extending direction of the track;
a plurality of cameras arranged along both sides of the track, and the visual fields of two adjacent cameras positioned on the same side of the track intersect in the extending direction of the track;
a three-dimensional model constructing device connected with the laser radar and the camera signals respectively, that constructs an original three-dimensional model on both sides of the track based on the point cloud data and the image data uploaded by the laser radar plus the camera; and
an early warning device arranged on the train for assisted driving and connection with the three-dimensional model building device by using signals.

The warning device updates and displays three-dimensional models on both sides of the track in real time.

According to the invention, a large number of laser radars and cameras are arranged on both sides of the track, so that a complete three-dimensional model on both sides of the track is constructed; therefore, when a driver drives a train, the driver can refer to the three-dimensional model provided by the early-warning device under the conditions of low visibility and small visual field, so that the driver can discover and make relief measures in time when an emergency occurs on the track. Moreover, compared with the solution that the laser radar and the camera are arranged on the train-on one hand, the solution can avoid the influence of the object occlusion and the detection accuracy of the long-distance object, and on the other hand, the detection accuracy will not be affected by factors such as the movement and vibration of the train during running, so as to ensure the accuracy of the three-dimensional model. In addition, although the cost of installing a large number of laser radars and cameras on the track is relatively high, all trains running on the railway can play an early warning role, so compared with a large number of trains running on the track, the average cost of one embodiment is not high.

Further, the lidar is used to acquire point cloud data on both sides of the track, and the camera is used to acquire image data on both sides of the track.

In one embodiment, point cloud data and image data are acquired by lidar and camera respectively, so point cloud data and image data can be fused to construct high-precision three-dimensional models.

In a rail transportation network, there are a lot of tracks and trains. If an early warning device needs to receive three-dimensional model information of all tracks, the information receiving amount is large, the three-dimensional model construction time is long, and the timeliness of early warning is worsened. Aiming at this problem, the invention provides the following technical solution.

The three-dimensional model constructing device comprises:
an information collecting unit connected to each laser radar and camera signal; and
a plurality of track model building units, wherein each track corresponds to a track model building unit, and each track model building unit is used for building a three-dimensional model corresponding to the track;

The information distribution unit is connected with each early warning device signal, the early warning device is used for uploading the track of the train to the information distribution unit, and the information distribution unit sends the corresponding three-dimensional model to the early warning device according to the track of the train.

In the technical solution provided by the present invention, each track model construction unit is configured to construct a three-dimensional track model corresponding to the track model construction unit. Thus, the information collected by the information collection unit can be forwarded to the corresponding track model construction unit in an orderly manner according to the track in which the information collection unit is located, thereby increasing the efficiency of information distribution. Meanwhile, for the early warning device, by sending the track that the early warning device needs to enter to the information distribution unit, the corresponding track model construction unit can be directly matched, so that the early warning device does not need to collect the three-dimensional model information of all tracks, the information transmission amount is reduced, and the timeliness of early warning is improved.

The train needs to provide enough information for the driver to make an early warning. Therefore, in practice, it is necessary to obtain not only the three-dimensional information of all objects on the track, but also the three-dimensional information of all objects on both sides of the track. For example, there is an object moving toward the track in front of the train, but it has not yet reached the track. If the object is displayed to the driver after reaching the track, the distance between the object and the train may be less than the shortest braking distance of the train. Therefore, in order to improve the timeliness of early warning, it is necessary to send the three-dimensional object information on both sides of the track to the early warning device, so as to play an early warning role. In one embodiment, the scope that the early warning device needs to pay attention to is too large, and the amount of information that needs to be received and processed is increased, which reduces the efficiency of establishing a three-dimensional model and reduces the timeliness of early warning. In view of this problem, the present invention provides the following technical solution:

The early warning device comprises:
a speed acquisition unit, configured to acquire the running speed and the shortest braking distance of the train, and send the running speed and the shortest braking distance to the information distribution unit; and
a model information acquisition unit signally connected to the information allocation unit, wherein the model information acquisition unit acquires all three-dimensional model information of the track in advance before the train enters the corresponding track, and constructs a static three-dimensional model; and
an information distribution unit configured to acquire a traveling speed and a current position of the train in real time, acquire an observation range of the train according to the traveling speed and the current position of the train, and send updated information indicating that there is a change in the observation range compared with a static three-dimensional model to the model information acquisition unit.

The height of the observation range relative to the ground is a fixed value, the horizontal distance between any point L on both sides of the observation range relative to the train centerline is L₁, and the route length along the train forward route where the current position of the train is farthest from the observation range is L₂; L₁=(V₁/L₀) V₂; L₂=Sᵥ+λS₀V₁, where V₁ is the current train speed, V₂ is the average moving speed of moving objects around the track, the length of L₀ point L to the plane where the train is located along the forward direction of the train, Sᵥ is the shortest braking distance at the current train speed, S₀ is the preset compensation distance, λ is the compensation coefficient, 0<λ<1.

In one embodiment, the observation range is related to the speed of the train and the shortest braking distance; if the speed of the train is fast and the braking distance is long, the corresponding observation range is longer; and if the speed of the train is slow and the shortest braking distance is short, the observation range is relatively shorter. At the same time, for trains with different speeds, the faster the speed, the larger the L₂, the longer the length of the observation range, but the same L₁ will be smaller. Therefore, in practice, the observation range of trains with different speeds and different qualities will be dynamically adjusted to ensure the safety of train driving under the condition of reducing the observation range of each train as much as possible.

In the real world, there are a lot of unexpected situations and the weather can change, so the raw information captured by lidar and cameras is very complex and changeable. If the change of the original information shot by the laser radar and the camera is directly used as the basis for sending the updated information to the three-dimensional model in the train early warning device, the early warning device will receive too much information and transmit a lot of information irrelevant to the assisted driving, thus affecting the timeliness of the assisted driving response. To solve this problem, the present invention provides the following technical solutions.

Further, the track model constructing unit comprises:
a point cloud data preprocessor that is used for preprocessing that point cloud data; and
an image data preprocessor for pre-processing image data;

The image fusion module is used for fusing that point cloud data and the image data to obtain fused data.

The information discriminator is used for receiving the fusion data, comparing the fusion data received by each detection group with the previous fusion data, if the fusion data is not changed, the fusion data does not belong to the updated information, and if the fusion data is changed, the fusion data belongs to the updated information.

In one embodiment, after receiving the point cloud data and the image data, the track model construction unit preprocesses the point cloud data and the image data and then generates the fusion data. Whether the fusion data belongs to the updating information is judged according to whether the three-dimensional model generated by the fusion data is the same as the original three-dimensional model. Therefore, in practice, the fusion data does not need to be deeply analyzed and form the three-dimensional model, and thus the fusion data does not need complex operation and only needs to express the corresponding characteristics. When the early warning device of the train needs the updated information of the area, the fusion data with changes is directly sent as the updated information, so that the early warning device needs to receive less data, and needs to calculate less data, and the timeliness of early warning is improved.

### BRIEF DESCRIPTION OF THE DRAWINGS

The accompanying drawings, which constitute part of this application, are intended to provide a further understanding of the application and to make the other features, objects, and advantages of the application more apparent. The accompanying drawings of the exemplary embodiments of the application and their descriptions are intended to explain the application and do not constitute an undue limitation of the application.

In addition, throughout the accompanying drawings, the same or similar reference numerals represent the same or similar elements. It should be understood that the drawings are schematic and that the elements are not necessarily drawn to scale.

FIG. 1 is a schematic diagram of the structure of the driving assistance system of a three-dimensional modeled rail train.

FIG. 2 is a schematic diagram of the observation range.

FIG. 3 is a schematic diagram of the key information transmission direction in the driving assistance system of a three-dimensional modeled rail train.

FIG. 4 is a flow chart of a method of driving assistance for a three-dimensional modeled rail train.

### DETAILED DESCRIPTION OF THE INVENTION

Although certain embodiments of the present invention are shown in the accompanying drawings, it is to be understood that the present invention may be embodied in various forms and should not be construed as limited to the embodiments set forth herein. It should be understood that the drawings and embodiments of the present invention are for illustrative purposes only and are not intended to limit the scope of protection of the present invention.

In addition, it should be noted that, for convenience of description, only parts related to the invention are shown in the drawings, and embodiments and features in embodiments of the present invention can be combined with each other in the case of no conflict.

Hereinafter, the present invention will be described in detail in conjunction with embodiments with reference to the accompanying drawings.

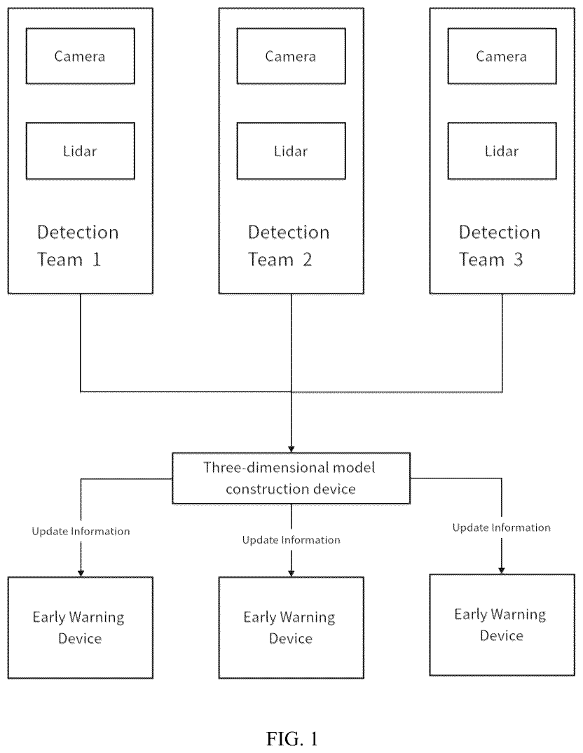

Referring to FIG. 1, Embodiment 1: The present invention provides a driving assistance system for a rail train based on three-dimensional modeling. The driving assistance system mainly installs a large number of vision sensors on both sides of the rail, and then constructs a dynamic three-dimensional model. When a driver drives a train, he can roughly understand the situation in front of the train according to the dynamic three-dimensional model, and understand the situation change outside the driver's field of vision. It is convenient for drivers to discover sudden problems early and use intervention means to deal with dynamic areas earlier.

The assisted driving system of the track train based on three-dimensional modeling comprises laser radar, camera, three-dimensional model building device and early warning device, wherein the laser radar is arranged along two sides of the track, the maximum detection range of two adjacent laser radars positioned on the same side of the track intersects in the track extending direction; the camera is arranged along two sides of the track, and the visual field range of two adjacent cameras positioned on the same side of the track intersects in the track extending direction. Lidar and camera are visual sensors. Lidar is used to capture motion information and position information of objects, and can calculate the position of objects. Camera is used to capture color information and shape information of objects. In 3D model construction technology, lidar and camera are generally used as the main information acquisition methods. The information acquired by lidar is point cloud data, and the information acquired by camera is image data.

In one embodiment, a lidar and a camera are set as a lidar and detection group, and the detection range of the lidar and the camera in a detection group is the same. Because 3D image data on both sides of the track are needed when constructing the 3D model, many detection groups are arranged on both sides of the track. These detection groups are used to obtain point cloud data and image data to complete the 3D model construction along both sides of the entire track.

In practice, because rail trains are generally electrically powered, a large number of detection groups can be installed on both sides of the fixed frame of the electrical installation.

For each detection group, the center line of detection is perpendicular to the track, and the detection range between adjacent detection groups overlaps with each other. Therefore, after collecting the information of all detection groups on the track, point cloud data and image data along all regions on both sides of the track can be obtained. Using the collected point cloud data and image data, a 3D model can be constructed along both sides of the track.

A three-dimensional model constructing device, that is connected with the laser radar and the camera signal respectively, and constructs original three-dimensional models on both sides of the track based on the point cloud data and the image data uploaded by the laser radar and the camera, wherein the three-dimensional model constructing device is actually a cloud service device. All the lidar and cameras will transmit the collected data to the 3D model building device, and then the 3D model building device will send different original 3D models or some updated information to the train. Therefore, the 3D model building device can be understood as a cloud service platform for the entire driving assistance system, where data collection, processing and distribution need to be handled.

An early-warning device arranged on a train for assisting driving and connected with a three-dimensional model building device by signals; and the early-warning device updates and displays three-dimensional models on two sides of a track in real time.

The three-dimensional model constructing device comprises information collecting unit, a track model constructing unit and an information distributing unit, wherein the information collecting unit is connected with each laser radar and camera signal; the information collecting unit is mainly used for collecting point cloud data and image data; and the information collected by the laser radar and the camera can be transmitted in real time.

A track model construction unit is provided, and each track corresponds to a track model construction unit, and each track model construction unit is used for constructing a three-dimensional model of the corresponding track. In actual track transportation, the number of tracks is large, and a complete transportation network is formed. Therefore, a track model construction unit is configured for each track, and is used for establishing a three-dimensional model of the track, and the three-dimensional model is actually an initial three-dimensional model around the track. In practice, the track model building unit updates the initial three-dimensional model of the track once or several times a day at a fixed time because the environment around the track changes.

The information distribution unit is connected with each early warning device by signals, the early warning device is used for uploading the track of the train to the information distribution unit, and the information distribution unit sends the track to the early warning device according to the initial three-dimensional model of the track where the train is located. Early warning devices are actually installed on each train to provide auxiliary guidance to the driver of the train. The train schedule and operation plan of the train are specified before the train runs, so before the train departs, the early warning device of the train sends the track to be selected to the information distribution unit, and then the information distribution unit finds the corresponding track model construction unit according to the track, obtains the initial three-dimensional model of the track from the track model construction unit, and then sends it to the early warning device.

The early warning device includes: The method which comprises a speed acquisition unit, a model information acquisition unit and a display unit, wherein the speed acquisition unit is used for acquiring the running speed and the shortest braking distance of the train and sending the running speed and the shortest braking distance to the information distribution unit; the model information acquisition unit is connected with the information distribution unit by signals; the model information acquisition unit acquires initial three-dimensional model information of the track in advance before the train enters the corresponding track, and constructs a static three-dimensional model; and the display unit is used for displaying the three-dimensional model.

In one embodiment, the speed acquisition unit will be directly connected with the train speed monitor signal to acquire the train speed and the shortest braking distance of the train. The shortest braking distance can generally be acquired from the train control center, which is an important parameter in train operation management. The specific calculation method or acquisition method will not be further described here.

The model information acquisition unit is actually a three-dimensional model calculation system located on the train, and similar to the track model construction unit, it can calculate the three-dimensional model according to the information received by the detection group. In one embodiment, the track model construction unit first sends an initial three-dimensional model calculated every day to the model information acquisition unit, the model information acquisition unit can obtain an initial three-dimensional model without calculation, then the information distribution unit continuously sends updated information to the model information acquisition unit, and the model information acquisition unit updates the three-dimensional model according to the updated information, and then displays the updated information on the display unit.

Because the track is very long, it is unrealistic to calculate the 3D model of too large of an area at one time. Therefore, the following methods are adopted to limit the calculation area of the 3D model in one embodiment.

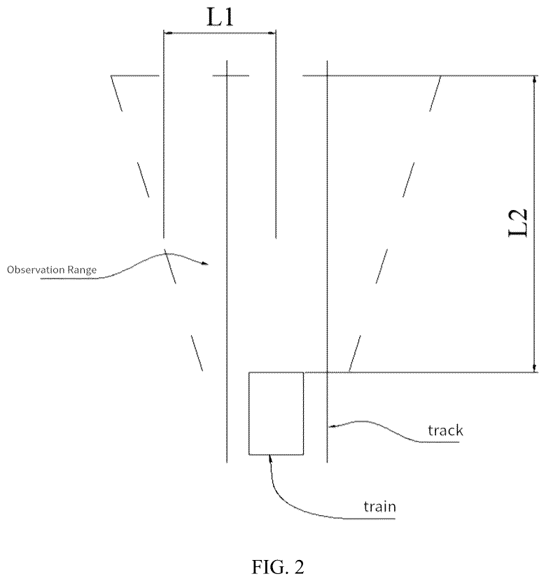

Referring to FIG. 2, the information distribution unit is configured to acquire a traveling speed and a current position of the train in real time, acquire an observation range of the train according to the traveling speed and the current position of the train, and send updated information indicating that there is a change in the observation range compared with a static three-dimensional model to the model information acquisition unit.

The height of the observation range compared with the ground is a fixed value, the horizontal distance between any point L on both sides of the observation range compared with the center line of the train on page 5/8 of the specification is L₁, and the route length of the current position of the train along the forward route of the train that is the farthest from the observation range is L₂; L₁=(V₁/L₀) V₂; L₂=Sᵥ+λS₀V₁, where V₁ is the current train speed, the length from L₀ point L to the plane where the train is located along the train forward direction, Sᵥ is the shortest braking distance at the current train speed, S₀ is the preset compensation distance, λ is the compensation coefficient, 0<λ<1. V₂ is the average moving speed of moving objects around the track. V₂ is actually an important index to measure the width of the observation range. If V₂ is set to be very large, it will lead to a wide observation range, which will reduce the calculation amount. In one embodiment, V₂ is set to the average moving speed of moving objects around the track, which is actually the general moving speed of the area crossed by the track. If the track crosses mostly mountain forests, the setting of V₂ only needs to be related to the rolling speed of stones on hillsides. If the track is intertwined with social vehicles, V₂ needs to be set to be related to the traveling speed of vehicles.

Thus, the observation range is a cone that spreads outward along the end of the train. Relatively speaking, if the train speed is fast, the cone is longer, but correspondingly narrower. If the train speed is low, the cone is shorter, but wider.

In one embodiment, the track model building unit is used to build an initial three-dimensional model, and then send the updated information to the model information acquiring unit, and the model information acquiring unit completes the update of the model. However, if the information detected by the detection group is new or is not directly used as the basis for updating the information, there will be a lot of redundant information, resulting in a lot of invalid information transmitted between the three-dimensional model building device and the early warning device.

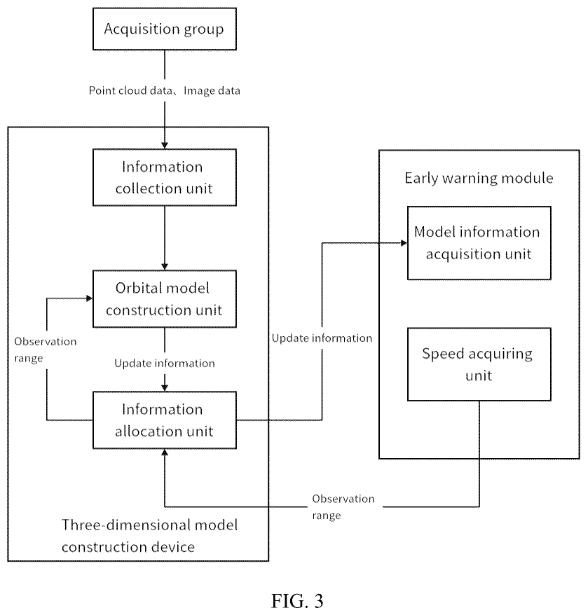

Referring to FIG. 3, the present invention provides the following technical solution: the track model construction unit comprises a point cloud data preprocessor, an image data preprocessor, an image fusion module, an information discriminator and an initial model generator, wherein the point cloud data preprocessor is used for preprocessing the point cloud data, the image data preprocessor is used for preprocessing the image data, the image fusion module is used for fusing the point cloud data and the image data to obtain fusion data, and the initial model generator is used for generating the fusion data.

The information discriminator is used for receiving the fusion data, comparing the fusion data received by each detection group with the previous fusion data, if the fusion data is not changed, the fusion data does not belong to the updated information, and if the fusion data is changed, the fusion data belongs to the updated information.

The information discriminator only judges whether the fusion data has changed, and the fusion data is actually simplified data that can form a model, and if the fusion data changes, the three-dimensional model will change, so as to judge whether it belongs to the updated information.

In practice, in order to reduce the workload of the information classifier, the information classifier only compares whether the fusion data in the observation range is updated information or not.

The initial model generator is a unit for constructing an initial three-dimensional model.

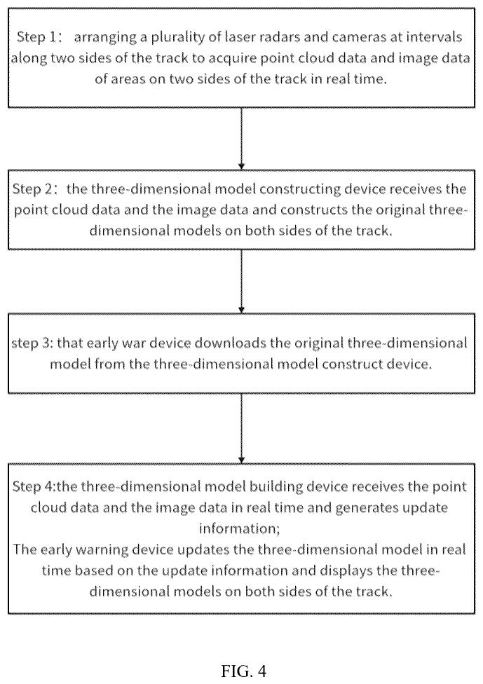

Referring to FIG. 4, Embodiment 2 is a method for assisting the driving of a rail train based on three-dimensional modeling, implemented by the system for assisting the driving of a rail train based on three-dimensional modeling of Embodiment 1.

The method comprises the following steps:

Step 1, arranging a plurality of laser radars and cameras at intervals along two sides of the track to acquire point cloud data and image data of areas on two sides of the track in real time.

Step 1 in one embodiment comprises the following steps.

Step 11, arranging a plurality of laser radars and cameras on both sides of the track, wherein one laser radar and one camera are set as a lidar and detection group, and the detection ranges of the laser radars and the cameras in the same detection group are the same.

The detection ranges of adjacent detection groups intersect in the track extension direction.

Step 12: The lidar and detection group collect point cloud data and image data in real time, and sends the point cloud data and image data to the three-dimensional model construction device.

Step 2, the three-dimensional model constructing device receives the point cloud data and the image data to construct original three-dimensional models on both sides of the track.

Step 2 in one embodiment includes the following steps:

Step 21, the information collecting unit downloads point cloud data and image data of regions on both sides of the track.

Step 22, the track model constructing unit generates an original three-dimensional model based on the point cloud data and the image data of the regions on both sides of the track.

Step 3, that early warning device downloads the original three-dimensional model from the three-dimensional model construction device.

Step 4, that three-dimensional model build device receives the point cloud data and the image data in real time and generates updated information.

The early warning device updates the three-dimensional model in real time based on the update information, and displays the three-dimensional models on both sides of the track.

Step 4 in one embodiment includes the following steps:

Step 41, the speed acquisition unit acquires the running speed and the shortest braking distance of the train, and sends the running speed and the shortest braking distance to the information distribution unit.

Step 42, the information distribution unit obtains the traveling speed and the current position of the train in real time, obtains the observation range of the train according to the traveling speed and the current position of the train, and sends update information indicating that there is a change in the observation range compared with the static three-dimensional model to the model information acquisition unit.

Step 42 in one embodiment includes the following steps:

In step 421, the point cloud data preprocessor and the image data preprocessor preprocess the point cloud data and the image data received in real time.

In step 422, the image fusion module fuses the preprocessed point cloud data and the image data to obtain fused data.

In step 423, the information discriminator compares the fusion data received by each detection group with the previous fusion data, and if the fusion data does not change, it does not belong to update information, and if it changes, it belongs to the updated information.

In step 424, the information distribution unit sends update information within the train observation range to the model information acquisition unit.

Embodiment 3: The assisted driving system and the assisted driving method for a rail train provided in Embodiment 1 and Embodiment 2, wherein the key part lies in how to construct a three-dimensional model and how to update the three-dimensional model. Therefore, the present invention provides the method for constructing the three-dimensional model as follows.

S1: collecting image data, preprocessing the image data, collecting point cloud data, preprocessing the point cloud data.

Pre-processing is conventional, mainly normalization, denoising and other operations.

S2: extracting feature points from the preprocessed image data by SIFT algorithm.

S3: Match different pictures in the image data based on the feature points to align the image data with each other.

S4, collecting the focal length of the camera and recovering the three-dimensional coordinates of the feature points by triangulation, so as to obtain the three-dimensional coordinates of the non-ground points.

S5: down-sampling the point cloud data, i.e. thinning.

S6: Identify and remove discrete points from the point cloud data.

In point cloud data, discrete points are those points that are far from the surrounding points and do not conform to the overall data distribution. These points may be due to measurement errors, equipment failures, or environmental factors. The existence of discrete points will cause interference with subsequent triangulation modeling, so it needs to be removed before triangulation. You can determine whether they are discrete points based on the point cloud density. Instructions page 7/8.

S7: Interpolate sparse point cloud by linear interpolation method, connect adjacent points, construct triangular mesh, and form triangular mesh digital ground model.

Point cloud data may become relatively sparse after downsampling and removing discrete points. To construct a continuous triangular mesh, sparse point clouds need to be interpolated.

S8: Integrate the triangulation model of ground points with the three-dimensional coordinate points of non-ground points.

After triangulating the ground points and restoring the 3D coordinates of the non-ground points, these two parts of data need to be integrated to form a complete 3D scene model.

In this embodiment, steps S1 to S8 are the same as the procedure of generating fused data in Embodiment 2, and determining whether or not the fused data has changed is the main method of determining whether or not the fused data is updated information.

S9: Use 3D modeling software or rendering engine.

Those skilled in the art should understand that the scope of the invention involved in the embodiments of the present invention is not limited to technical solutions formed by specific combinations of the above technical features, but also covers other technical solutions formed by arbitrary combinations of the above technical features or equivalent features without departing from the inventive concept—for example, the technical solution formed by replacing the above features with (but not limited to) technical features having similar functions disclosed in the embodiments of the present invention.

What is claimed is:

1. An assisted driving system of a rail train based on three-dimensional modeling, comprising of:
a plurality of laser radars arranged along both sides of the track, and the maximum detection ranges of two adjacent laser radars located on the same side of the track intersect in the extending direction of the track;
a plurality of cameras arranged along both sides of the track, and the visual fields of two adjacent cameras positioned on the same side of the track intersect in the extending direction of the track;
a three-dimensional model constructing device connected with the laser radar and the camera signals respectively, and constructing an original three-dimensional model on both sides of the track based on the point cloud data and the image data uploaded by the laser radar and the camera; and
an early warning device arranged on the train for assisting driving and connected with the three-dimensional model building device by signals;
wherein the early warning device updates in real time and displays three-dimensional models on both sides of the track; the laser radar is used to obtain point cloud data on both sides of the track, and the camera is used to obtain image data on both sides of the track;
wherein the three-dimensional model constructing device comprises:
an information collecting unit connected to each laser radar and camera signal;
a plurality of track model building units, wherein each track corresponds to a track model building unit, and each track model building unit is used for building a three-dimensional model corresponding to the track; and
an information distribution unit connected with each early warning device signal, the early warning device is used for uploading the track of the train to the information distribution unit, and the information distribution unit sends the corresponding three-dimensional model to the early warning device according to the track of the train;
wherein the early warning device comprises:
a speed acquisition unit, configured to acquire the running speed and the shortest braking distance of the train, and send the running speed and the shortest braking distance to the information distribution unit; and
a model information acquisition unit signally connected to the information allocation unit; wherein the model information acquiring unit acquires all three-dimensional model information of the track in advance before the train enters the corresponding track, and constructs a static three-dimensional model;
wherein the information distribution unit is configured to acquire a traveling speed and a current position of the train in real time, acquire an observation range of the train according to the traveling speed and the current position of the train, and send updated information indicating that there is a change in the observation range compared with a static three-dimensional model to the model information acquisition unit; and
wherein the height of the observation range relative to the ground is a fixed value, the horizontal distance between any point L on both sides of the observation range relative to the train centerline is L₁, and the route length along the train forward route where the current position of the train is farthest from the observation range is L₂; L₁=(V₁/L₀) V₂; L₂=Sᵥ+λS₀V₁, where V₁ is the current train speed, the length of L₀ point L to the plane where the train is located along the forward direction of the train, Sᵥ is the shortest braking distance at the current train speed, S₀ is the preset compensation distance, λ is the compensation coefficient, 0<λ<1, and V₂ is the average moving speed of moving objects around the track.

2. The driving assistance system of claim 1, wherein the rail model construction unit comprises:
a point cloud data preprocessor, configured to preprocess point cloud data;
an image data preprocessor, configured to preprocess image data;
an image fusion module, configured to fuse point cloud data and image data to obtain fusion data; and
an information discriminator, configured to receive the fusion data and compare the fusion data received by each detection group with the previous fusion data. If the fusion data does not change, it does not belong to update information, and if it changes, it belongs to update information.

3. A method for assisting driving of a rail train based on three-dimensional modeling, performed with the system of claim 1; comprising of:
step 1, arranging the laser radar and the cameras at intervals along two sides of a track, and acquiring point cloud data and image data of areas on two sides of that track in real time;
step 2, receiving point cloud data and image data to construct original three-dimensional models on two side of a track, by the three-dimensional model construction device;
step 3, downloading the original three-dimensional model from the three-dimensional model construct device, by the early warning device; and
step 4, receiving the point cloud data and the image data in real time and generating updated information, by the three-dimensional model build device;
wherein the early warning device updates the three-dimensional model in real time based on the update information, and displays the three-dimensional models on both sides of the track.

4. The method of claim 3, wherein step 1 comprises:
step 11, arranging the laser radars and the cameras on both sides of the track, wherein one laser radar and one camera are set as a lidar and detection group, the detection ranges of the laser radars and the cameras in the same detection group are the same, and the detection ranges of adjacent detection groups intersect in the track extension direction; and
step 12: collecting point cloud data and image data in real time, and sending the point cloud data and image data to the three-dimensional model construction device, by the lidar and detection group.

5. The method of claim 4, wherein step 2 comprises:
step 21, downloading point cloud data and image data of regions on both sides of the track using the information collecting unit; and
step 22, generating an original three-dimensional model based on the point cloud data and the image data of the regions on both sides of the track using the track model constructing unit.

6. The method of claim 5, wherein step 4 comprises:
step 41, acquiring the running speed and the shortest braking distance of the train, and sending the running speed and the shortest braking distance to the information distribution unit, by the speed acquisition unit; and
step 42, obtaining the traveling speed and the current position of the train in real time, obtaining the observation range of the train according to the traveling speed and the current position of the train, and sending updated information indicating that there is a change in the observation range compared with the static three-dimensional model to the model information acquisition unit, by the information distribution unit.

7. The method of claim 6, wherein step 42 comprises:
step 421, preprocessing the point cloud data and the image data received in real time, by the point cloud data preprocessor and the image data preprocessor.
step 422, fusing the preprocessed point cloud data and the image data to obtain fused data, by the image fusion module.
step 423, comparing the fusion data received by each detection group with the previous fusion data, using the information discriminator, and if the fusion data does not change, it does not belong to updated information, and if it changes, it belongs to updated information; and
step 424, sending updated information within the train observation range to the model information acquisition unit, by the information distribution unit.
